(19) United States
(12) Patent Application Publication
(10) Pub. No.: US 2014/0344250 A1
(43) Pub. Date: Nov. 20, 2014

(54) ENHANCED SEARCH REFINEMENT FOR PERSONAL INFORMATION SERVICES

(71) Applicant: Microsoft Corporation, Redmond, WA (US)

(72) Inventors: Kutlay Topatan, Seattle, WA (US); Irum Iqbal Godil, Bellevue, WA (US); Selvaraj Nalliah, Redmond, WA (US)

(73) Assignee: Microsoft Corporation, Redmond, WA (US)

(21) Appl. No.: 13/898,142

(22) Filed: May 20, 2013

(51) Int. Cl. G06F 17/30

(52) U.S. Cl. CPC G06F 17/30554
USPC 707/722

(57) ABSTRACT

Systems, methods, and software are disclosed herein for implementing enhanced search refinement. In at least one implementation, a search is initiated of information items in a personal information database based. The search may be performed based on, for example, a search query received through a user interface to a personal information service. Search results are presented via the user interface, as well as various suggested refiners with which to refine the search. Prior to refining the search results, at least more than one of the suggested refiners may be selected or otherwise indicated as of interest. The search results are then refined using the selected refiners and the refined results presented through the user interface.

### TECHNICAL FIELD

Aspects of the disclosure are related to computing hardware and software technology, and in particular to search refiners for personal information services.

### TECHNICAL BACKGROUND

Personal information services provide users with effective and convenient ways to communicate with others and to manage their personal information. Users typically engage with personal information services through user interfaces provided by associated personal information applications, such as email applications, calendar applications, and task management applications, as well as combinations and variations thereof. Some representative personal information applications and services include Microsoft® Outlook®, Outlook® Web App (OWA), Hotmail®, Gmail®, and Yahoo® Mail, as well as others.

When engaged with a personal information service, a user may interact with various personal information items via a user interface to the service. Examples of such items include emails, contacts, calendar items, tasks, and the like. In a typical scenario, a user's personal information items are stored in a personal information database, such as a mailbox, that is accessed as the user interacts with the application.

Most personal information applications provide users with a search capability for searching their personal information items, such as a search box in the user interface through which search queries may be entered. Various search tools are also provided in many cases, examples of which include auto-suggest and refiners. An auto-suggest feature provides query suggestions within a search box as search strings are typed, while refiners are a quick way to refine or narrow search results.

In one example involving refiners, email items may be searched and search results returned. Metadata associated with the search results can be analyzed to identify various refiners to display along with the search results, for example in a side panel. The user can narrow their search results by selecting one of the refiners, examples of which include the sender or recipient, date, and attachment status of the emails in the search results. The results are refined immediately upon selection of one of the refiners. New refiners are presented with respect to the refined search results, the selection of one of which triggers another refinement of the search results, and so on until a desired level of refinement is reached.

### OVERVIEW

Provided herein are systems, methods, and software for implementing enhanced search refinement. In at least one implementation, a search is initiated of information items in a personal information database based. The search may be performed based on, for example, a search query received through a user interface to a personal information service. Search results are presented via the user interface, as well as various suggested refiners with which to refine the search. Prior to refining the search results, at least more than one of the suggested refiners may be selected or otherwise indicated as of interest. The search results are then refined using the selected refiners and the refined results presented through the user interface. In some implementations, the suggested refiners may include, for example, keyword refiners derived from the content of the information items. In some implementations, search results may be refined using only a single keyword refiner.

This Overview is provided to introduce a selection of concepts in a simplified form that are further described below in the Technical Disclosure. It should be understood that this Overview is not intended to identify key features or essential features of the claimed subject matter, nor is it intended to be used to limit the scope of the claimed subject matter.

### BRIEF DESCRIPTION OF THE DRAWINGS

Many aspects of the disclosure can be better understood with reference to the following drawings. While several implementations are described in connection with these drawings, the disclosure is not limited to the implementations disclosed herein. On the contrary, the intent is to cover all alternatives, modifications, and equivalents.

FIG. 1 illustrates a user interface to a personal information service and various operational features in an implementation.

FIG. 2 illustrates an enhanced refinement process carried out by a suitable computing platform or platforms in an implementation.

FIG. 3 illustrates a computing architecture suitable for implementing any computing platform in an implementation.

FIG. 4 illustrates a service environment in an implementation in which various computing platforms provide a personal information service.

FIG. 5 illustrates a user interface to a personal information service and various operational features in an implementation.

FIG. 6 illustrates a user interface to a personal information service and various operational features in an implementation.

FIG. 7 illustrates a user interface to a personal information service and various operational features in an implementation.

FIG. 8 illustrates a user interface to a personal information service and various operational features in an implementation.

### TECHNICAL DISCLOSURE

Implementations disclosed herein enable enhanced search refinement whereby the results of a search may be refined using multiple, concurrently selected refiners such that the results are narrowed based on more than one refiner. Two or more refiners may be considered concurrently selected with respect to one another when indications of interest are made with respect to each refiner prior to refining the search results. In other words, two or more refiners may be considered concurrently selected if the selected refiners can be identified to a refinement process prior to an execution of the process.

In a brief example, search results are returned and presented though a user interface to a personal information service, along with various suggested refiners with which to refine the search results. A user interacting with the user interface may provide an indication of interest with respect to one of the suggested refiners, such as by touching, clicking on, or otherwise selecting the refiner. Prior to refining the search results, the user may then provide another indication of interest with respect to another one of the suggested refiners, again by touch, clicking on, or otherwise selecting the refiner. Thus, the two selected refiners may be considered concurrently selected with respect to each other and can be used by a refinement process to refine the search results.

Examples of personal information services include, but are not limited to, email services, scheduling services, and other services that allow users to exchange and organize various types of information. In various implementations the search may be performed on a personal information database having information items stored therein. A mailbox is one example of a personal information database, in which case emails are examples of information items. Other information items are possible, such as calendar events, tasks, contacts, instant chat messages, text messages, and micro-blog posts, as well as any other type of personal information item that may be found in a searchable database.

The suggested refiners may include a variety of types of refiners, such as category refiners and keyword refiners. The suggested refiners may be arranged in accordance with various categories that correspond respectively to detail categories in the search results. For example, a set of emails returned by a search can be categorized by the details of each email, such as sender, recipient, date, and attachment details. Thus, the suggested refiners may include details in accordance with these categories.

In some implementations the suggested refiners include keywords derived from the search results. A keyword category may be presented along with the other categories discussed above. In some scenarios a keyword category is presented in a stand-alone fashion. Suggested refiners may be identified in a variety of ways, for example, by examining search results and deriving the refiners therefrom. It may be appreciated that other search tools may be provided along with the suggested refiners, such as a query suggestion tool that automatically presents query suggestions with which to complete or augment a search string or search query. In some situations, a keyword refiner may be removed upon it being determined that it is duplicative in view of a selected query suggestion.

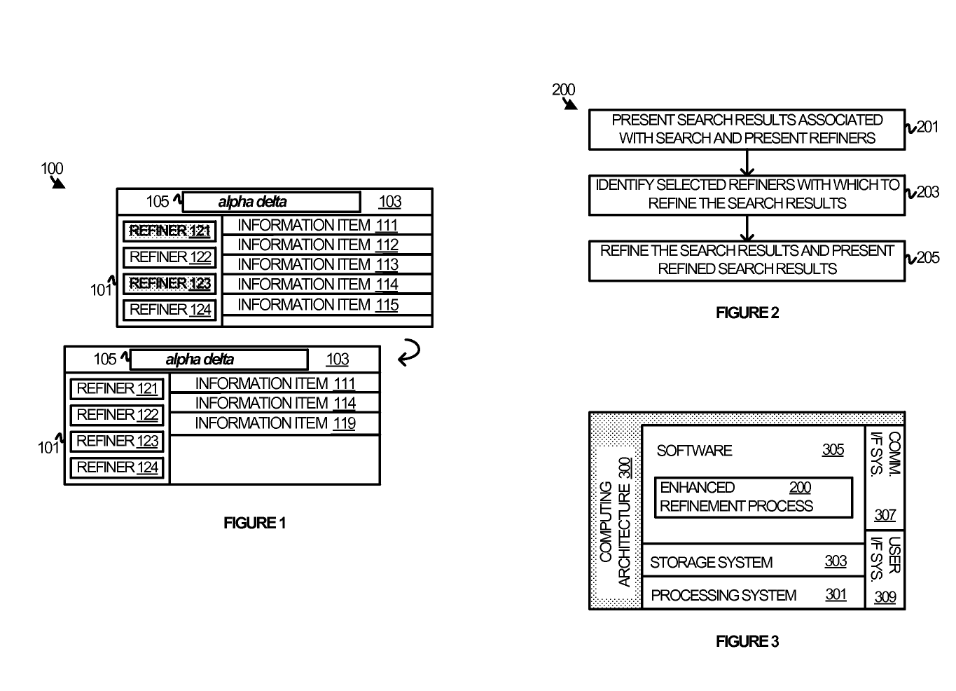

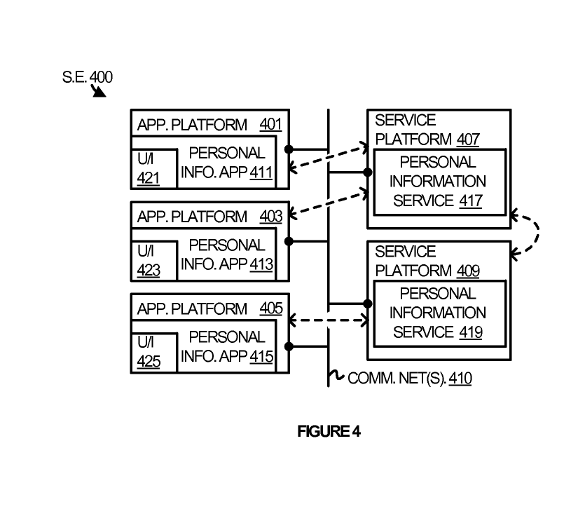

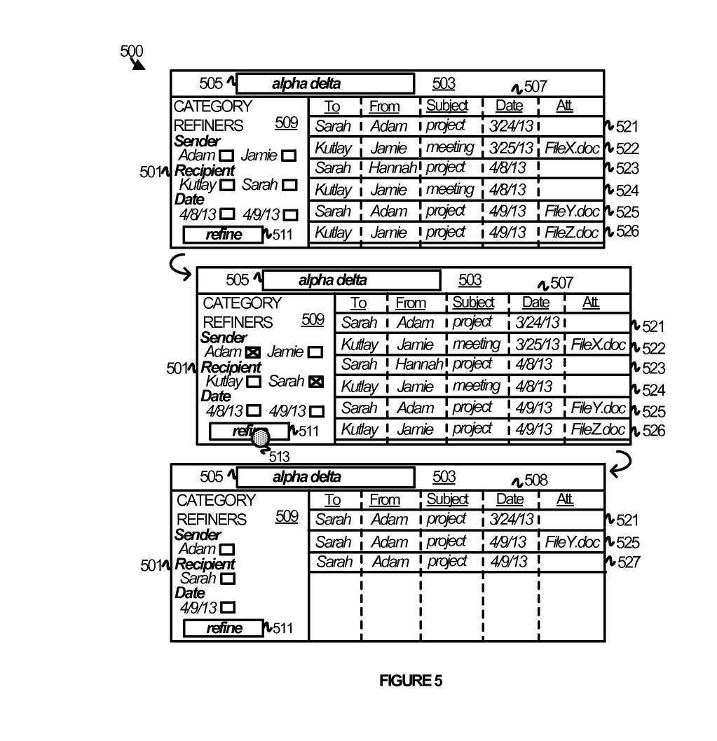

Referring now to the drawings, FIG. 1 illustrates various features and functionality that may be experienced through a user interface 101 when an enhanced refinement process 200, illustrated in FIG. 2, is implemented. The enhanced refinement process 200 may be embodied in software executable by any suitable computing system or collection of systems employing a suitable computing architecture, of which computing architecture 300 in FIG. 3 is representative. The user interface 101 and its associated features and functionality may be rendered, surfaced, or otherwise presented and experienced when the software is executed. FIG. 4 illustrates a service environment 400 in which a personal information service may be provisioned and delivered, while FIGS. 5-8 illustrate another user interface 501 and various operational features and functionality.

In particular, FIG. 1 illustrates an operational scenario 100 involving a user interface 101 to a personal information service in an implementation. User interface 101 provides an interface through which a user may interact with various aspects of a personal information service. Examples of user interface 101 include graphical user interfaces, natural user interfaces, web-based user interfaces, gesture-based user interfaces, and object-oriented user interfaces, as well as any other type of user interface, combinations or variations thereof.

User interface 101 includes an application bar 103 which may be used to present various tools, information, features, or other aspects of a personal information service. Application bar 103 includes search box 105, in which a user may enter search queries. Search queries entered via search box 105 launch searches of a personal information database associated with the user that contains personal information items. In an example, a user may initiate a search through search box 105 of their emails stored in their mailbox. User interface 101 may include other aspects not discussed herein for purposes of clarity.

User interface 101 may be presented when, for example, a personal information application or other software associated with the personal information service is executed, while the various features and functionality illustrated by operational scenario 100 may be experienced when enhanced refinement process 200 is implemented in such software. Examples of software in which enhanced refinement process 200 may be implemented include, but are not limited to, personal information applications, browser applications, client-side programs, and server-side programs, as well as any other type of software program, combination of programs, or variations thereof. The execution of any such program or collection of programs by any suitable computing system or systems drives the system or systems to operate as described herein for enhanced refinement process 200. Accordingly, the following discussion of operational scenario 100 makes reference parenthetically to the steps included in and illustrated with respect to enhanced refinement process 200.

In operation, a user may interact with user interface 101 to search, via search box 105, a personal information database. Other mechanisms for inputting or otherwise initiating a search query are possible and may be considered within the scope of the present disclosure. For exemplary purposes it is assumed in operational scenario 100 that the user has entered a search query “alpha delta” in search box 105, with which the search is performed and search results are returned. The search results may include various information items relevant to the search query that are retrieved from the personal information. Accordingly, the search results are presented along with various suggested refiners with which to refine the search (step 201). Information items 111-115 are representative of the search results and may include, for example, relevant emails, contacts, tasks, calendar events, and the like. Refiners 121-124 are representative of the suggested refiners and may be any data, words, dates, symbols, or other information with which the search results can be refined.

Prior to refining the search results, refiners are identified from the suggested refiners based on multiple indications of interest that may be made by the user through user interface 101 with respect to the suggested refiners (step 203). In this example, it is assumed for exemplary purposes that refiner 121 and refiner 123 have been selected, and thus may be considered concurrently selected refiners. Each of the multiple indications of interest may be made by the user by, for example, clicking on, touching, referencing via speech, or otherwise selecting the refiner. Other ways in which an indication of interest can be made are possible and may be considered within the scope of the present disclosure.

Once the selected refiners are identified, which in this case include refiner 121 and refiner 123, the research results are refined and the refined search results are presented (step 205). The refined search results include information item 111, information item 114, and information item 119, representative of a smaller set of items relative to those returned with the initial search results. It may also be appreciated that information item 119 was not visually apparent in the initial set of search results. This is intended to represent that the initial set of search results may sometimes include more items than can be visually presented within user interface 101.

Variations of enhanced refinement process 200 are possible and may be considered within the scope of the present disclosure. For example, other steps in addition to those described herein may be performed. In addition, variations on the steps described herein are possible, including initiating a particular function or feature. In an example, enhanced refinement 200 as discussed herein includes the steps of presenting search results and presenting refined search results. A variation of each could include initiating the presentation of search results and initiating the presentation of refined search results. Other variations are possible and may be considered within the scope of the present disclosure.

Referring now to FIG. 3, computing architecture 300 is representative of an architecture that may be employed in any computing apparatus or system or collections thereof to suitably implement all or portions of enhanced refinement process 200 or variations thereof, and optionally all or portions of the personal information application referred to with respect to FIG. 1. Computing architecture 300 may be employed in, for example, desktop computers, laptop computers, tablet computers, notebook computers, mobile computing devices, cell phones, media devices, and gaming devices, as well as any other type of physical or virtual computing machine and any combination or variation thereof. Computing architecture 300 may also be employed in, for example, server computers, cloud computing platforms, data centers, any physical or virtual computing machine, and any variation or combination thereof.

Enhanced refinement process 200 may be implemented on a single computing system or may be implemented in a distributed manner. The personal information application may also be implemented on a single computing system or may be implemented in a distributed manner. Enhanced refinement process 200 may be integrated with the personal information application, but may also stand alone or be embodied in some other application.

Computing architecture 300 includes processing system 301, storage system 303, software 305, communication interface system 307, and user interface system 309. Processing system 301 is operatively coupled with storage system 303, communication interface system 307, and user interface system 309. Processing system 301 loads and executes software 305 from storage system 303. When executed by processing system 301, software 305 directs processing system 301 or other elements of computing architecture 300 to operate as described herein for enhanced refinement process 200 or its variations. Computing architecture 300 may optionally include additional devices, features, or functionality not discussed here for purposes of brevity.

Referring still to FIG. 3, processing system 301 may comprise a microprocessor and other circuitry that retrieves and executes software 305 from storage system 303. Processing system 301 may be implemented within a single processing device but may also be distributed across multiple processing devices or sub-systems that cooperate in executing program instructions. Examples of processing system 301 include general purpose central processing units, application specific processors, systems on a chip, and logic devices, as well as any other type of processing device, combinations, or variations.

Storage system 303 may comprise any computer readable storage media readable by processing system 301 and capable of storing software 305. Storage system 303 may include volatile and nonvolatile, removable and non-removable media implemented in any method or technology for storage of information, such as computer readable instructions, data structures, program modules, or other data. Examples of storage media include random access memory, read only memory, magnetic disks, optical disks, flash memory, virtual memory and non-virtual memory, magnetic cassettes, magnetic tape, magnetic disk storage or other magnetic storage devices, or any other suitable storage media. In no case is the storage media a propagated signal. In addition to storage media, in some implementations storage system 303 may also include computer readable communication media over which software 305 may be communicated internally or externally.

Storage system 303 may be implemented as a single storage device but may also be implemented across multiple storage devices or sub-systems co-located or distributed relative to each other. Storage system 303 may comprise additional elements, such as a controller, capable of communicating with processing system 301 or possibly other systems.

Software 305 may be implemented in program instructions and among other functions may, when executed by processing system 301, direct processing system 301 or other elements of computing architecture 300 to operate as described herein for enhanced refinement process 200. For example, the program instructions may, when executed by processing system 301, may direct processing system 301 to examine search results from a search of a personal information database to identify suggested refiners with which to refine the plurality of search results, initiate presentation the of search results and the suggested refiners in a user interface to a personal information service, in response to an indication to refine the search results received through the user interface, identify from the suggested refiners more than one concurrently selected refiners with which to refine the search results, refine the search results using the concurrently selected refiners, and initiate presentation of the refined search results in the user interface.

The program instructions may include various components or modules that cooperate or otherwise interact to carry out enhanced refinement process 200. The various components or modules may be embodied in compiled instructions or interpreted instructions or in some other variation of or combination of instructions. The various components or modules may be executed in a synchronous or asynchronous manner, in a serial or in parallel, in a single threaded environment or multi-threaded, or in accordance with any other suitable execution paradigm, variation, or combination thereof.

Software 305 may include additional processes, programs, or components, such as operating system software or other application software. Software 305 may also comprise firmware or some other form of machine-readable processing instructions executable by processing system 301.

In general, software 305 may, when loaded into processing system 301 and executed, transform a suitable apparatus, system, or device employing computing architecture 300 overall from a general-purpose computing system into a special-purpose computing system customized to facilitate enhanced search refinement as described herein for each implementation. Indeed, encoding software 305 on storage system 303 may transform the physical structure of storage system 303. The specific transformation of the physical structure may depend on various factors in different implementations of this description. Examples of such factors may include, but are not limited to the technology used to implement the storage media of storage system 303 and whether the computer-storage media are characterized as primary or secondary storage, as well as other factors.

For example, if the computer-storage media are implemented as semiconductor-based memory, software 305 may transform the physical state of the semiconductor memory when the program is encoded therein, such as by transforming the state of transistors, capacitors, or other discrete circuit elements constituting the semiconductor memory. A similar transformation may occur with respect to magnetic or optical media. Other transformations of physical media are possible without departing from the scope of the present description, with the foregoing examples provided only to facilitate this discussion.

Referring again to FIG. 1, through the operation of a suitable computing system implementing enhanced refinement process 200, transformations may be performed with respect to user interface 101. As an example, user interface 101 could be considered transformed from one state to another when subject to enhanced refinement process 200 variations thereof. In a first state, user interface 101 includes search results related to an initial search of a personal information database. The search results are refined using concurrently selected refiners, at which point refined search results are returned and presented in user interface 101, thereby changing user interface 101 to a different state.

It should be understood that computing architecture 300 is generally intended to represent an architecture on which software 305 may be deployed and executed in order to implement enhanced refinement process 200 (or variations thereof) and optionally all or portions of a personal information application. However, computing architecture 300 may also be suitable for any computing system on which software 305 may be staged and from where software 305 may be distributed, transported, downloaded, or otherwise provided to yet another computing system for deployment and execution, or yet additional distribution.

Communication interface system 307 may include communication connections and devices that allow for communication with other computing systems over a network or collection of networks. Examples of connections and devices that together allow for inter-system communication may include network interface cards, antennas, power amplifiers, RF circuitry, transceivers, and other communication circuitry. The connections and devices may communicate over communication media to exchange communications with other computing systems or networks of systems, such as metal, glass, air, or any other suitable communication media. The aforementioned communication media, network, connections, and devices are well known and need not be discussed at length here.

User interface system 309 may include a mouse, a voice input device, a touch input device for receiving a touch gesture from a user, a motion input device for detecting non-touch gestures and other motions by a user, and other comparable input devices and associated processing elements capable of receiving user input from a user. Output devices such as a display, speakers, haptic devices, and other types of output devices may also be included in user interface system 309. In some cases, the input and output devices may be combined in a single device, such as a display capable of displaying images and receiving touch gestures. The aforementioned user input and output devices are well known in the art and need not be discussed at length here.

User interface system 309 may include associated user interface software executable by processing system 301 in support of the various user input and output devices discussed above. Separately or in conjunction with each other and other hardware and software elements, the user interface software and devices may support a graphical user interface, a natural user interface, or the like. In operation, user interface system 309 is capable of presenting a user interface to a personal information service, such as user interface 101 illustrated in FIG. 1. As such, a user may interact with a personal information service and associated applications through user interface 101 by way of user interface system 309.

FIG. 4 illustrates a service environment 400 in which various personal information applications may implement all or portions of enhanced refinement process 200. Service environment 400 includes application platform 401, application platform 403, and application platform 405, service platform 407, service platform 409, and communication network 410. Application platform 401 and application platform 403 communicate with service platform 407 to access personal information service 417 on behalf of personal information application 411 and personal information application 413 respectively. Application platform 405 communicates with service platform 409 to access personal information service 419 on behalf of personal information application 415. From time to time, service platform 407 and service platform 409 may communicate to enable interaction between personal information service 417 and personal information service 419, and by extension interaction by application platforms 401 and 403 with application platform 405.

Examples of application platforms 401, 403, and 405, include, but are not limited to, desktop computers, work stations, laptop computers, notebook computers, tablet computers, mobile phones, personal digital assistants, media devices, gaming devices, routers, and any other physical or virtual computing machine, or combinations and variations thereof, capable of implementing at least one of a variety of personal information applications. Service platform 407 may be any computing system or collection of computing systems capable of implementing a personal information service 417, while service platform 407 may be any computing system or collection of computing systems capable of implementing a personal information service 419.

Application platforms 401, 403, and 405 may each be any computing apparatus, system, device, or collections thereof that employ a computing architecture suitable for implementing personal information applications 411, 413, and 415 respectively, the execution of which results in the rendering or presentation of user interfaces 421, 423, and 425 respectively. Computing architecture 300 referred to with respect to FIG. 3 is one such representative architecture. Personal information applications 411, 413, and 415 may each be any version or variety of personal information application. Examples include but are not limited to locally installed and executed applications, streamed applications, web-based applications that execute at least in part within the context of a browser application, mobile applications, mobile web-based applications that execute at least in part within the context of a mobile browser application, or any other application type, variation, or combination thereof.

User interfaces 421, 423, and 425 may each be any type of software interface that enables a user to interact with a personal information service. The execution of personal information applications 411, 413, and 425 by application platforms 401, 403, and 405 results in the presentation of user interfaces 421, 423, and 425 by way of their respective user interface systems, of which user interface system 309 is representative. Examples of user interfaces 421, 423, and 425 include graphical user interfaces, natural user interfaces, web-based user interfaces, gesture-based user interfaces, and object-oriented user interfaces, as well as any other type of user interface, combinations or variations thereof. An exemplary user interface 501 various associated features and functions are discussed below with respect to FIG. 5.

Personal information applications 411, 413, and 415 may each be embodied in program instructions that, when executed by application platforms 401, 403, and 405 respectively direct each to operate as described herein for enhanced refinement process 200 discussed with respect to FIG. 2. The program instructions may take the form of compiled object code, interpreted scripts, or any other suitable form of program instructions that may be executed directly or indirectly by an application platform, as well as any suitable variation or combination thereof. Examples of personal information applications include but are not limited to Microsoft® Outlook®, Mozilla Thunderbird/Lightening, Open Xchange, Microsoft® Outlook® Web App, Microsoft® Outlook® Web App for mobile devices, Outlook.com®, Gmail, and Microsoft® Outlook® for mobile devices, as well as another suitable personal information application, variation, or combination thereof.

Service platform 407 and service platform 409 may each include any computing apparatus, system, device, or collections thereof that employ a computing architecture suitable for implementing personal information service 417 and personal information service 419 respectively. Computing architecture 300 referred to with respect to FIG. 3 is one such representative architecture. Examples include server computers, cloud computing platforms, data centers, and any physical or virtual computing machine, as well as any variation or combination thereof. Examples of personal information service 417 and personal information service 419 include but are not limited to Microsoft® Exchange®, Microsoft® O365®, Hotmail®, Outlook.com®, and Gmail, as well as any other information exchange service, combination, or variation thereof capable of operating as described herein.

In operation, any of applications platforms 401, 403, and 405 may communicate from time to time with service platform 407 or service platform 409 over communication network 410 to facilitate the exchange of information between personal information applications 411 and 413 and personal information service 417, and between personal information application 415 and personal information service 419. Service platform 407 and service platform 409 may also communicate over communication network 410 to facilitate the exchange of information. For example, information may be exchanged to facilitate the sending and receiving of email, the creation and monitoring of calendar events, the creation and monitoring of tasks, and to facilitate the searching of email, events, and tasks, as well as for other reasons. Such communication is generally well known in the art and need not be discussed at length here.

Communication between any of the elements contemplated in FIG. 4 may occur in accordance with various communication protocols, such as the Internet protocol (IP, IPv4, IPv6, etc.), the transfer control protocol (TCP), and the user datagram protocol (UDP), as well as any other suitable communication protocol, variation, or combination thereof. Communication network 410 may be representative of a network or collection of networks over which the elements contemplated in FIG. 4 may exchange information, such as an intranet, the Internet, a local area network, a wide area network, a wireless network, a wired network, or any combination or variation thereof. Communication network 410 may include connections, devices, and communication media, such as metal, glass, air, or any other suitable communication media over which information may be exchanged. The aforementioned communication media, network, connections, protocols, and devices are well known and need not be discussed at length here.

The manner and format in which information is exchanged may vary. In some implementations, a personal information application may exchange information with a personal information service in accordance with various protocols, such as IMAP (internet message access protocol), POP (post office protocol), SMTP (simple mail transfer protocol), OWA (Outlook Web App) webmail protocol, various other webmail protocols, various proprietary protocols, HTTP (hypertext transfer protocol), REST (representational state transfer), Web Socket, DOM (Document Object Model), HTML (hypertext markup language), CSS (cascading style sheets), HTML5, XML (extensible markup language), JavaScript, JSON (JavaScript Object Notation), and AJAX (Asynchronous JavaScript and XML), as well as any other suitable protocol, variation, or combination thereof.

In operation, a client device (application platforms 401, 403, 405) running a personal information application communicates a search query to a service platform (407, 409). The search query may be based on a search string or some other input entered by a user through a user interface (user interfaces 421, 423, and 425) to the personal information service that is rendered when the personal information application is executed. The service platform then searches a relevant personal information database and returns the search results to the client device for presentation through a user interface, such as user interfaces 421, 423, and 425. In some implementations, all or portions of the search may be performed locally with respect to the client device.

Search refiners may be presented along with the search results. The refiners can be identified by the server that performs the search and returned to the client device with the search results. However, the refiners can also be identified by the client device within the context of executing the personal information application. The search refiners can be used to refine the search results and may even be derived from the search results. In an example, the search results are examined to identify category information with which to potentially refine the results. Examples of category information include the sender, recipient, and date of each email in a group of emails. Another example includes the originator, invitees, and date of a calendar event. A variety of categories are possible and may be considered within the scope of this disclosure. In another example, the content of each of the search results is examined to identify keywords with which refine the search results. For instance, the body of each email contained in search results may be examined and keywords derived therefrom.

The refiners are displayed along with the search results in the user interface, for instance in a side panel of the user interface. The user may select one or more of the refiners such that multiple refiners are concurrently selected. For example, the user may select one refiner, and then select another refiner. A refinement process may then be initiated that refines the search results using the multiple, concurrently selected refiners. The refiners may be any number of category refiners, keyword refiners, or any other type of refiner, as well as combinations ore variations thereof. The search results are then refined accordingly and the refined search results presented in the user interface. The refinement process may be carried out by the client device, the service platform, or some combination of both.

FIGS. 5-8 illustrate various operational scenarios involving a user interface to a personal information service. The various features and functionality illustrated with respect to the operational scenarios may be experienced when, for example, enhanced refinement process 200 or variations thereof are carried out by a suitable computing system running a personal information application. User interface 501 is representative of user interfaces 421, 423, and 425 illustrated in FIG. 4. Examples of user interface 101 include graphical user interfaces, natural user interfaces, web-based user interfaces, gesture-based user interfaces, and object-oriented user interfaces, as well as any other type of user interface, combinations or variations thereof.

Referring to FIG. 5, operational scenario 500 is illustrated involving user interface 501 in an implementation. User interface 501 includes an application bar 503 which may be used to present various tools, information, features, or other aspects of a personal information service. Application bar 503 includes search box 505, in which a user may enter search queries. Search queries entered via search box 505 launch searches of a personal information database associated with the user that contains personal information items. In an example, a user may initiate a search through search box 505 of their emails stored in their mailbox. The search may be based on, for example, a search string (“alpha delta”). Search results 507 may then be presented in user interface 501. In this example, the search results 507 include a list of emails 521-526. User interface 501 may include other aspects not discussed herein for purposes of clarity.

It may be appreciated that the emails can be defined or described using various categories, such as the sender, recipient, subject, date, and attachment status of each email. For example, email 521 was sent from Adam to Sarah on March 24^{th}. The subject of the email was a “project” and it had no attachment. Accordingly, the search results 507 can be refined based on these categories using the category refiners 509 displayed in a side panel of the user interface 501. In this example the category refiners 509 enable a user to refine the search results 507 by sender, recipient, or date, although other refiners are possible in addition to or in place of these refiners.

As mentioned, the specific refiners that are included in the category refiners 509 may be derived from the search results 507 themselves. Thus, the sender refiners include “Adam” and “Jamie,” while the recipient refiners include “Kutlay” and “Sarah.” The date refiner includes April 8^{th} and April 9^{th}. Note that these refiners are provided merely for non-limiting, exemplary purposes. Which category refiners are provided and how they are selected can be accomplished in a variety of ways that may be considered within the scope of the present disclosure.

Next, the user may provide multiple indications of interest, each pertaining to a different one of the category refiners 509. For illustrative purposes it is assumed here that the refiner specifying “Adam” as a sender is selected and the refiner specifying “Sarah” as a recipient is selected. The indications of interest are not illustrated in FIG. 5, although it may be appreciated that they may be accomplished in a variety of ways, such as by a mouse click, touch gesture, spoken indication, or in some other suitable manner.

Upon selecting the multiple refiners, the user may provide another input 513 with respect to a refine button 511, in response to which the search results 507 are refined using the concurrently selected refiners. The input 513 may be a click, a touch, or some other gesture or command that triggers the personal information application to initiate a refinement process using the selected refiners. Refine button 511 is just one example of how the command may be accomplished, although it may be possible to implement such a feature or function using some other type of graphical element. It may also be possible to implement such a feature or function without any button or other graphical element. For example, a key stroke, specific gesture, spoken command, or any other input may suffice to trigger the refinement process. In fact, the refinement process could be triggered upon the selection of a second refiner. For example, upon selecting the first refiner (“Adam”), the refinement process would not execute, but after selecting the second refiner (“Sarah”), the refinement process would be automatically triggered and executed.

Regardless of the manner in which the refinement process is triggered, the search results 507 are refined to refined search results 508 based on the concurrently selected refiners. The refined search results 508 include email 521, email 525, and email 527. Notice that each email was sent to Sarah from Adam. In other words, the search results 507 were refined to the refined search results 508 based on these constraints.

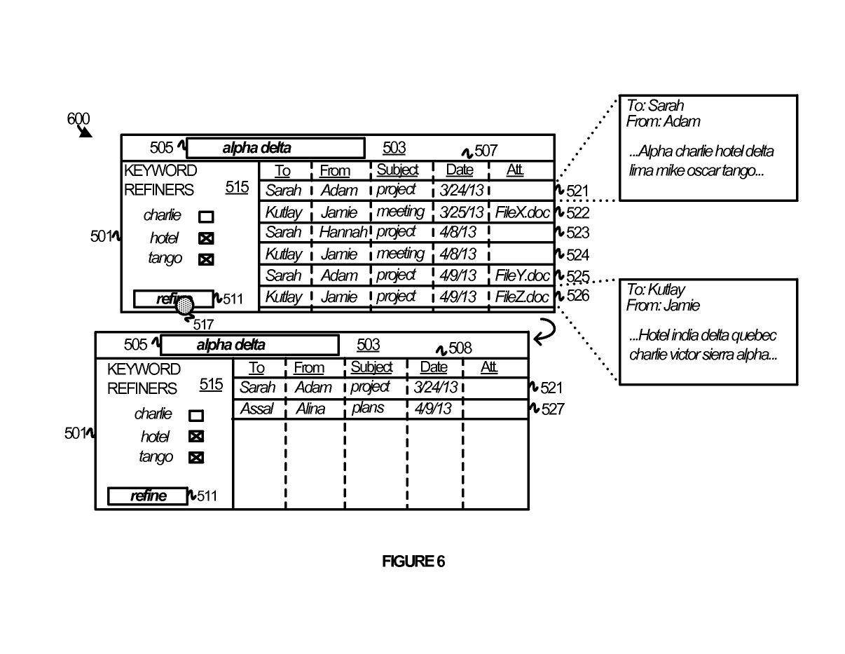

Referring to FIG. 6, operational scenario 600 is illustrated involving user interface 501 in another implementation. In this implementation, keyword refiners are identified based at least on the content of search results. In operation, a user may initiate a search through search box 505 of their emails stored in their mailbox. The search may be based on, for example, a search string (“alpha delta”). Search results 507 may then be presented in user interface 501. In this example, the search results 507 include a list of emails 521-526. User interface 501 may include other aspects not discussed herein for purposes of clarity.

It may be appreciated that the emails include various forms of content, such a written text, attachments, or other such content. Accordingly, the search results 507 can be refined based on keywords derived from the content, represented by keyword refiners 515. For exemplary purposes, the content of email 521 and email 526 is shown. Keyword refiners 515 include various words taken from the content: charlie, hotel, and tango. In this example the keyword refiners 515 enable a user to refine the search results 507 by any one or more of the keywords, although other refiners are possible in addition to or in place of these refiners. In addition, other types of refiners in addition to keywords are possible.

Next, the user may provide multiple indications of interest, each pertaining to a different one of the keyword refiners 515. For illustrative purposes it is assumed here that the refiner specifying “hotel” is selected and the refiner specifying “tango” is selected. The indications of interest are not illustrated in FIG. 5, although it may be appreciated that they may be accomplished in a variety of ways, such as by a mouse click, touch gesture, spoken indication, or in some other suitable manner.

Upon selecting the multiple refiners, the user may provide another input 517 with respect to refine button 511, in response to which the search results 507 are refined using the concurrently selected refiners. The input 517 may be a click, a touch, or some other gesture or command that triggers the personal information application to initiate a refinement process using the selected refiners. As mentioned, refine button 511 is just one example of how the command may be accomplished, although it may be possible to implement such a feature or function using some other type of graphical element. It may also be possible to implement such a feature or function without any button or other graphical element. For example, a key stroke, specific gesture, spoken command, or any other input may suffice to trigger the refinement process. In fact, the refinement process could be triggered upon the selection of a second refiner. For example, upon selecting the first refiner (“hotel”), the refinement process would not execute, but after selecting the second refiner (“tango”), the refinement process would be automatically triggered and executed.

Regardless of the manner in which the refinement process is triggered, the search results 507 are refined to refined search results 508 based on the concurrently selected refiners. The refined search results 508 include email 521, and email 527. Notice that each email had the word “tango” or “hotel” in it. Again, it may be understood that the process of refining results may happen in a variety of ways. In this example, the search results 507 were filtered in an OR fashion, although they could have been filtered in an AND fashion or in accordance with any other type of search logic.

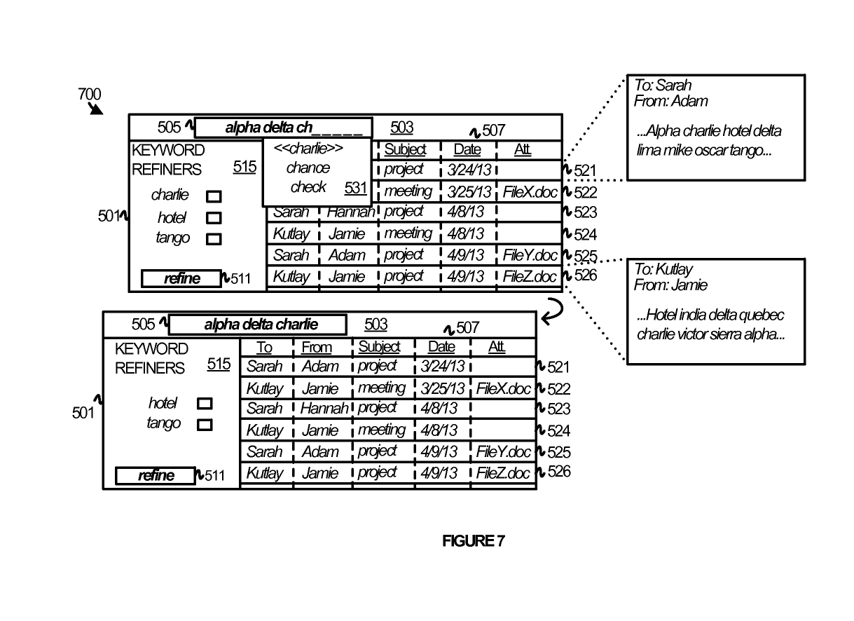

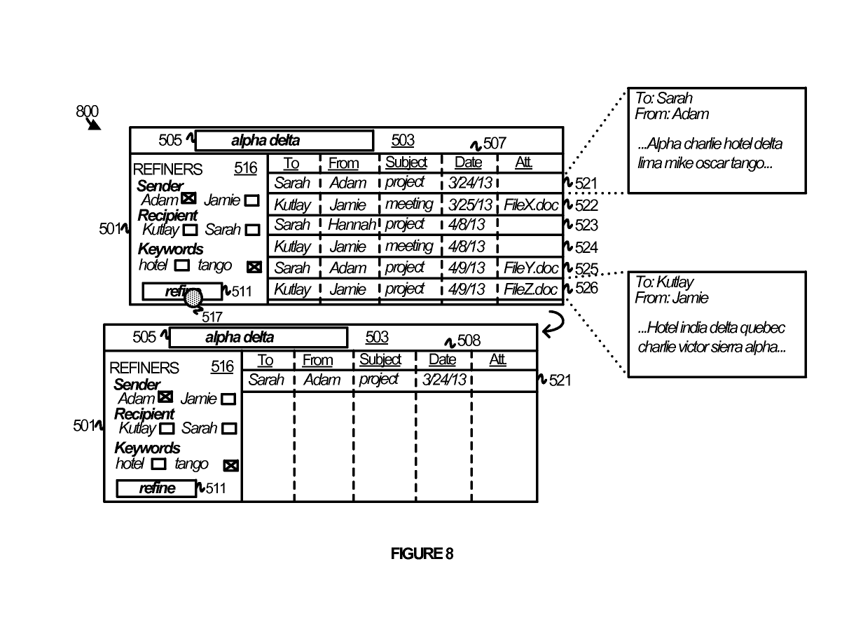

FIG. 7 illustrates another operational scenario 700 that may occur with respect to user interface 501. In this scenario, a user has entered a search string “alpha delta” that resulted in search results 507. In addition, keyword refiners 515 were returned with the search results and presented in user interface 501.

In addition to the features and functions discussed with respect to FIG. 5 and FIG. 6, in this scenario the user proceeds to enter an additional term in search box 505 by inputting the characters “c” and “h.” In this example, it is assumed for exemplary purposes that the personal information application rendering user interface 501 includes an auto-suggest feature that provides query suggestions based on strings or partial-strings entered into a search box. The auto-suggest feature results in a drop-down menu that displays various suggestions to complete the new term: charlie, chance, and check.

Note that the word “charlie” in the suggestions is the same as one of the keyword refiners 515 provided in the user interface 501. In response to detecting a query suggestion that is duplicative with respect to one of the keyword refiners 515, the personal information application removes the respective keyword from the keyword refiners 515. Accordingly, the remaining keyword refiners 515 include the word tango and hotel.

Such a feature may be accomplished in a variety of ways. For example, a process may be implemented in the personal information application that monitors which words are suggested by an auto-complete feature and compares them against which words are provided in a group of keyword refiners. Any words in the group of keywords that are duplicative with respect to a word provided by auto-suggest can be removed or otherwise modified. In this way, confusion can be avoided between suggested query terms and refiners.

FIG. 8 illustrates yet another operational scenario 800 involving user interface 501. Operational scenario 800 illustrates that both category refiners and keyword refiners can be provided simultaneously in user interface 501. In this example, a group of refiners 516 includes both category refiners pertaining to the sender and recipient of the search results 507, as well as keywords related to the content of the search results.

In operation, a user provides multiple indications of interest, one with respect to a category refiner and one with respect to a keyword refiner. The search results 507 are filtered based on both refiners and refined search results 508 returned accordingly. In this example, the refiners narrow the search results 507 to emails sent by Adam and having the word “tango” included therein, resulting in just email 521.

The functional block diagrams, operational sequences, and other diagrams provided in the Figures are representative of exemplary architectures, environments, and methodologies for performing novel aspects of the disclosure. While, for purposes of simplicity of explanation, methods included herein may be in the form of a functional diagram, operational sequence, or flow diagram, and may be described as a series of acts, it is to be understood and appreciated that the methods are not limited by the order of acts, as some acts may, in accordance therewith, occur in a different order and/or concurrently with other acts from that shown and described herein. For example, those skilled in the art will understand and appreciate that a method could alternatively be represented as a series of interrelated states or events, such as in a state diagram. Moreover, not all acts illustrated in a methodology may be required for a novel implementation.

The included descriptions and figures depict specific implementations to teach those skilled in the art how to make and use the best option. For the purpose of teaching inventive principles, some conventional aspects have been simplified or omitted. Those skilled in the art will appreciate variations from these implementations that fall within the scope of the invention. Those skilled in the art will also appreciate that the features described above can be combined in various ways to form multiple implementations. As a result, the invention is not limited to the specific implementations described above, but only by the claims and their equivalents.

What is claimed is:

1. One or more computer readable storage media having a personal information application stored thereon for facilitating enhanced search refinement that, when executed by a computing system, directs the computing system to at least:
initiate a search of a plurality of information items in a personal information database based at least in part on a search query received through a user interface to a personal information service;
present in the user interface of a plurality of search results associated with the search and a plurality of suggested refiners with which to refine the search;
prior to refining the plurality of search results identify, based at least in part on a plurality of indications of interest made through the user interface with respect to the plurality of suggested refiners, a plurality of selected refiners with which to refine the plurality of search results; and
using at least the plurality of selected refiners, refine the plurality of search results to a plurality of refined search results and present the plurality of refined search results.

2. The one or more computer readable storage media of claim 1 wherein the personal information application further directs the computing system to derive the plurality of suggested refiners from the plurality of search results.

3. The one or more computer readable storage media of claim 1 wherein the personal information application further directs the computing system to arrange the plurality of suggested refiners in a plurality of categories.

4. The one or more computer readable storage media of claim 3 wherein the plurality of suggested refiners includes a plurality of keywords derived from the plurality of search results and the plurality of categories includes a keyword category having the plurality of keywords presented therein.

5. The one or more computer readable storage media of claim 4 wherein the plurality of categories further comprises a plurality of detail categories corresponding respectively to a plurality of details of each of the plurality of search results.

6. The one or more computer readable storage media of claim 5 wherein the personal information application further directs the computing system to identify a query suggestion in response to a modification of the search query received through the user interface, determine whether or not the query suggestion is duplicative with respect to at least one of the plurality of keywords, and remove the at least one of the plurality of keywords in response to determining that the query suggestion is duplicative.

7. The computer readable storage media of claim 1 wherein the personal information service comprises an email service, wherein the personal information application comprises an email application, wherein the plurality of information items comprises a plurality of email items, and wherein the personal information database comprises a mailbox.

8. A method for facilitating enhanced refinement of searches in personal information services, the method comprising:
examining a plurality of search results from a search of a personal information database to identify a plurality of suggested refiners with which to refine the plurality of search results;
presenting the plurality of search results and the plurality of suggested refiners in a user interface to a personal information service, each of the plurality of suggested refiners concurrently selectable with at least one other of the plurality of suggested refiners;
in response to an indication to refine the plurality of search results received through the user interface, identifying from the plurality of suggested refiners a plurality of concurrently selected refiners with which to refine the plurality of search results;
refining the plurality of search results to a plurality of refined search results based at least in part on the plurality of concurrently selected refiners; and
presenting the plurality of refined search results in the user interface.

9. The method of claim 8 further comprising deriving the plurality of suggested refiners from the plurality of search results.

10. The method of claim 8 further comprising arranging the plurality of suggested refiners in a plurality of categories.

11. The method of claim 10 wherein the plurality of categories includes a keyword category, wherein the plurality of suggested refiners includes a plurality of keywords derived from the plurality of search results, and wherein the presenting the plurality of suggested refiners includes presenting the plurality of keywords in the keyword category.

12. The method of claim 11 wherein the plurality of categories further comprises a plurality of detail categories corresponding respectively to a plurality of details of each of the plurality of search results.

13. The method of claim 12 wherein method further comprises presenting at least a search suggestion in addition to and separate from the presentation of the plurality of the suggested refiners.

14. The method of claim 8 wherein the personal information service comprises an email service, wherein the plurality of information items comprises a plurality of email items, and wherein the personal information database comprises a mailbox.

15. A computing apparatus comprising:
one or more computer readable storage media; and
program instructions stored on the one or more computer readable storage media that, when executed by a processing system, direct the processing system to at least:
initiate a search of a plurality of information items in a personal information database based at least in part on a search query received through a user interface to a personal information service;
present in the user interface a plurality of search results from the search and a plurality of suggested refiners, including a plurality of categories and a plurality of keywords derived from the plurality of search results;
refine the plurality of search results to a plurality of refined search results based on at least one of the plurality of suggested refiners;
present the plurality of refined search results in the user interface.

16. The computing apparatus of claim 15 wherein the program instructions further direct the processing system to examine the plurality of search results to identify the plurality of suggested refiners.

17. The computing apparatus of claim 15 wherein each of the plurality of suggested refiners comprises a refiner concurrently selectable with at least one other refiner of the plurality of suggested refiners.

18. The computing apparatus of claim 17 wherein, prior to refining the plurality of search results, the program instructions direct the processing system to identify a plurality of concurrently selected refiners with which to refine the plurality of search results.

19. The computing apparatus of claim 15 wherein the program instructions further direct the processing system to identify a query suggestion in response to a modification to the search query received through the user interface, determine whether or not the query suggestion is duplicative with respect to at least one of the plurality of keywords, and remove the at least one of the plurality of keywords in response to determining that the query suggestion is duplicative.

20. The computing apparatus of claim 15 further comprising the processing system configured to execute the program instructions, wherein the personal information service comprises an email service, wherein the plurality of information items comprises a plurality of email items, and wherein the personal information database comprises a mailbox.
